(19) United States
(12) Patent Application Publication
(10) Pub. No.: US 2016/0193769 A1
(43) Pub. Date: Jul. 7, 2016

(54) Cavity Assembly for a Preform Molding System

(71) Applicant: MOLD-MASTERS (2007) LIMITED, Georgetown (CA)

(72) Inventor: Sheldon RODINSKY, Brantford, (CA)

(73) Assignee: MOLD-MASTERS (2007) LIMITED, Georgetown, ON (CA)

(21) Appl. No.: 14/911,962

(22) PCT Filed: Aug. 15, 2014
(86) PCT No.: PCT/CA2014/000625

§ 371 Date: Feb. 12, 2016

Related U.S. Application Data
(60) Provisional application No. 61/866,903, filed on Aug. 16, 2013.

(51) Int. Cl. B29C 45/73; B29C 45/27; B29B 11/08

(52) U.S. Cl. CPC B29C 45/7312; B29B 11/08; B29C 45/2711; B29L 2023/00

(57) ABSTRACT

Disclosed is a preform molding system having a cavity assembly having an end forming portion and a body forming portion. A cooling chamber is defined between the cavity assembly and a surrounding structure. An outside surface of the end forming portion and an outside surface of the body forming portion are spaced apart from the surrounding structure, and, in operation, are engulfed in a flow of cooling fluid within the cooling chamber. Also disclosed is a preform mold stack having a cavity assembly that has end and body forming portions for molding a preform. An annular cooling chamber is defined at least in part by the cavity assembly, and is for cooling a preform molded in the cavity assembly. The annular cooling chamber extends in a longitudinal direction along the length of the end and body forming portions of the cavity assembly.

### FIELD

The invention relates to preform injection molding systems, and in particular to a cooling channel arrangement in a cavity insert assembly for a preform mold stack.

### BACKGROUND

In the art of injection molding, a typical mold will contain one or more mold cavities, the shape of which corresponds to the shape of a molded article produced therein. In operation, an injection molding machine injects a melt stream of moldable material into each mold cavity, via a runner system, where it is allowed to solidify for a period of time before the mold is opened and newly molded parts are ejected.

A factor affecting the cycle time required to produce a molded article is the time required to solidify or cool the newly molded article within the mold cavity to a state where it can be ejected/handled without being damaged.

In preform injection molding applications (molding of thick-walled, test-tube shaped intermediate products that are blow molded into a container), the ability to rapidly cool a newly molded preform while it is in the mold is important since, in many instances, the newly molded preform is removed from the mold by a post-mold cooling device as soon as it has solidified to a point where it can be handled without being damaged, but before it is fully cooled.

In preform molding systems, an assembly of components, known in the art as a mold stack, defines the shape of the mold cavity in which a preform is molded. The shape of the inside surface of the preform is defined by a mold core, whereas the shape of the outside surface is defined by a gate insert, a cavity insert, and a pair of thread splits or neck rings. Rapid cooling of the preform from the outside is important since it is the outer surface of the preform that is typically handled by the post-mold cooing device. Furthermore, effective cooling of the upstream end of the preform is important since this is the last portion of the preform to fill with molding material, and as such, molding material in this portion of the mold cavity is cooled for the least amount of time before the newly molded preform is ejected from the mold cavity. That being said, inadequate or inefficient cooling of the outside of the preform can result in defective molded articles, and/or can have a negative impact on the molding cycle time.

As such, a need exists in the art for cavity assembly cooling fluid passageway that provides rapid and efficient cooling to the end and body portions of a preform.

### SUMMARY OF THE INVENTION

Embodiments hereof are directed to a preform molding system having a cavity assembly that has an end forming portion and a body forming portion. A cooling chamber for cooling a preform molded in the cavity assembly is defined between the cavity assembly and a surrounding structure. An outside surface of the end forming portion and an outside surface of the body forming portion are spaced apart from the surrounding structure, and, in operation, are engulfed in a flow of cooling fluid within the cooling chamber.

Further Embodiments hereof are directed to a preform molding system having a cavity assembly that defines in part a mold cavity for molding preform that has an end portion and a body portion. The cavity assembly has an end forming portion and a body forming portion. A cooling chamber is defined by the outside surfaces of the end and body forming portions and a surrounding structure. The cooling chamber has a decompression chamber surrounding the end forming portion, and a tubular passageway surrounding the body forming portion. The tubular passageway projects from the decompression chamber and extends along the length of the mold cavity.

Further embodiments hereof are directed to a preform mold stack having a cavity assembly that has end and body forming portions for molding a preform. An annular cooling chamber is defined at least in part by the cavity assembly, and is for cooling a preform molded in the cavity assembly. The annular cooling chamber extends in a longitudinal direction along the length of the end and body forming portions of the cavity assembly.

### BRIEF DESCRIPTION OF DRAWINGS

The foregoing and other features and advantages of the invention will be apparent from the following description of the invention as illustrated in the accompanying drawings. The accompanying drawings, which are incorporated herein and form a part of the specification, further serve to explain the principles of the invention and to enable a person skilled in the pertinent art to make and use the invention. The drawings may not be to scale.

FIG. 1 is a sectional view of a portion of a preform injection molding apparatus with a cavity assembly in accordance with an embodiment hereof.

FIG. 2 is an enlarged view of a portion of a cavity half of FIG. 1.

FIG. 2A is a sectional view of FIG. 2 taken along line A-A.

FIG. 2B is an enlarged view of a portion B of FIG. 2.

FIG. 3 is an exploded view of the cavity assembly of FIG. 2.

FIG. 4 is a sectional view of a portion of a cavity half of a preform injection molding apparatus with a cavity assembly in accordance with another embodiment hereof.

FIG. 5 is a sectional view of a portion of a cavity half of a preform injection molding apparatus with a cavity assembly in accordance with another embodiment hereof.

FIG. 5A is a sectional view of FIG. 5 taken along line A-A.

FIG. 5B is a sectional view of FIG. 5 taken along line B-B.

FIG. 6 is a sectional view of a portion of a cavity half of a preform injection molding apparatus having a cavity assembly in accordance with another embodiment hereof.

FIG. 6A is a sectional view of FIG. 6 taken along line A-A.

FIG. 6B is an enlarged view of a portion B FIG. 6.

FIG. 7 is cross sectional view of a portion of a cavity half of a preform injection molding system having a cavity assembly in accordance with another embodiment hereof.

FIG. 7A is a sectional view of FIG. 7 A taken along line A-A.

FIG. 7AA is an alternative sectional view of FIG. 7 taken along line A-A.

### DETAILED DESCRIPTION OF THE INVENTION

Specific embodiments of the present invention will now be described with reference to the figures, wherein like reference numbers indicate identical or functionally similar elements. The following detailed description is merely exemplary in nature and is not intended to limit the invention or the application and uses of the invention. A person skilled in the relevant art will recognize that other configurations and arrangements can be used without departing from the scope of the invention. In the following description, “downstream” is used with reference to the flow of molding material as the mold cavity is filled and also to the order of components, or features thereof, through which the mold material flows as the mold cavity is filled, whereas “upstream” is used with reference to the opposite direction. Furthermore, there is no intention to be bound by any expressed or implied theory presented in the preceding technical field, background, brief summary or the following detailed description.

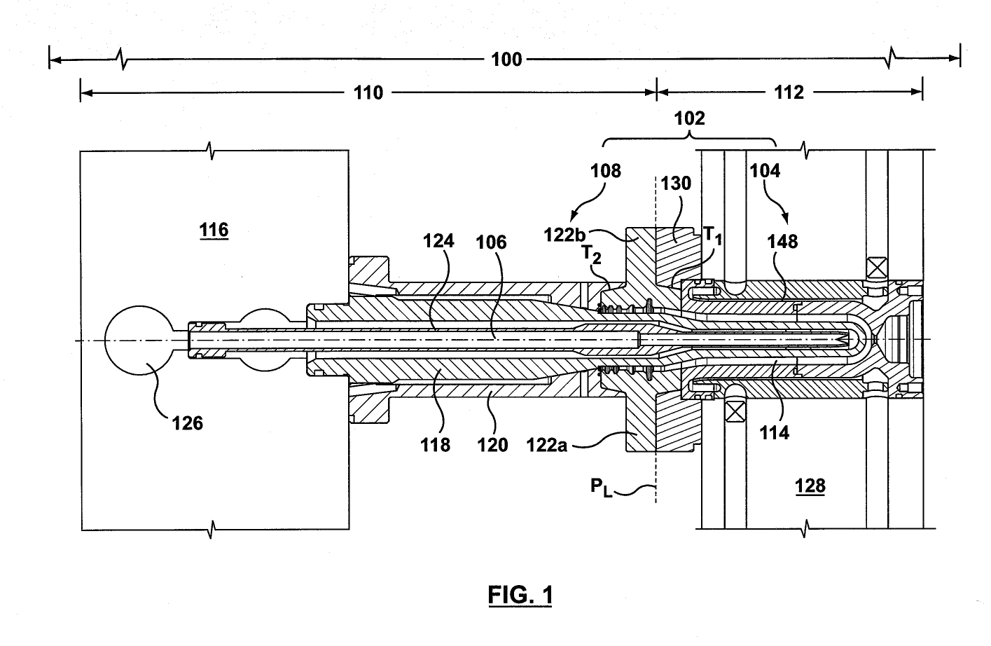

FIG. 1 is a sectional view of a portion of a preform injection molding apparatus 100 having a mold stack 102 with a cavity assembly 104 in accordance with an exemplary embodiment hereof. In a typical preform molding application a plurality of mold stacks 102 are arranged within preform injection molding apparatus 100 in an array that corresponds to the number of preforms molded during each injection molding cycle. Mold stack 102 is concentric about a central axis 106, and can be generally divided into a core assembly 108 and cavity assembly 104, separable along a parting line P_{L}, with core assembly 108 being associated with core half 110 and cavity assembly 104 being associated with cavity half 112. Core assembly 108 and cavity assembly 104 cooperate to define a mold cavity 114, the shape of which corresponds to the shape of the molded article, or preform, formed therein.

Core half 110 generally includes a core plate 116 and core assembly 108 which includes a mold core 118 and a core support or core lock 120. Core half 110 further includes a pair of split thread inserts or neck rings which includes first split thread insert 122a and second split thread insert 122b. Mold core 118 defines the internal shape of the cylindrical body portion and terminal end portion of a preform produced in mold cavity 114. Mold core 118 includes a cooling mechanism, such as a bubbler tube 124 in fluid communication with a suitable supply channel 126 provided in core plate 116. A cooling fluid is circulated through mold core 118 and bubbler tube 124 so as to maintain mold core 118 at a suitable molding temperature that cools and solidifies the melt stream of moldable material injected into mold cavity 114 during each injection cycle. Split thread inserts 122a, 122b define the external molding surface for the thread and taper regions of a preform produced in mold cavity 114, and include a cooling mechanism or cooling channel (not shown). For example, each of split thread inserts 122a, 122b can be provided with a cooling circuit similar to that disclosed in U.S. Pat. No. 5,599,567 which is incorporated by reference in its entirety herein. As is generally known in the art, split thread inserts 122a, 122b are configured to be actuated by sliders or similar mechanism (not shown) mounted on a stripper plate (also not shown) to translate forwardly and laterally during the ejection portion of a molding cycle.

Cavity half 112 includes a cavity plate 128 having cavity assembly 104 located therein. Cavity assembly 104 defines an elongate annular cooling chamber, or cooling passageway 148 that surrounds, and extends substantially the entire length of the portion of mold cavity 114 that is defined by cavity half 112. Cavity half 112 further includes an alignment ring 130 to assist in locating cavity assembly 104 relative to core assembly 108.

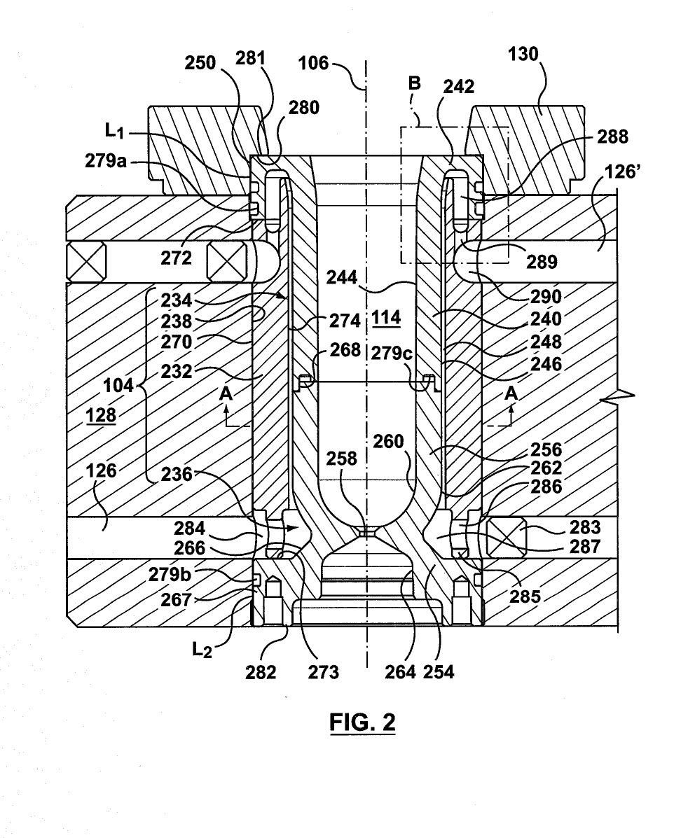

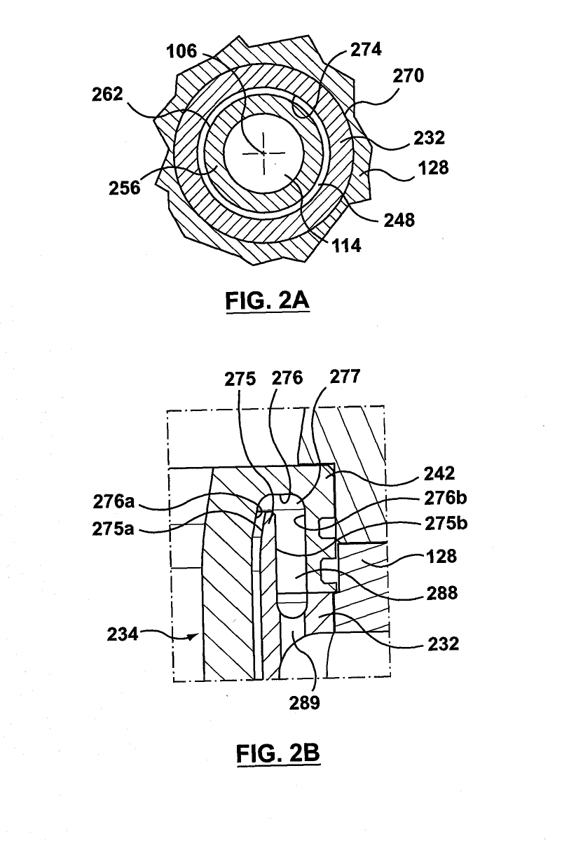

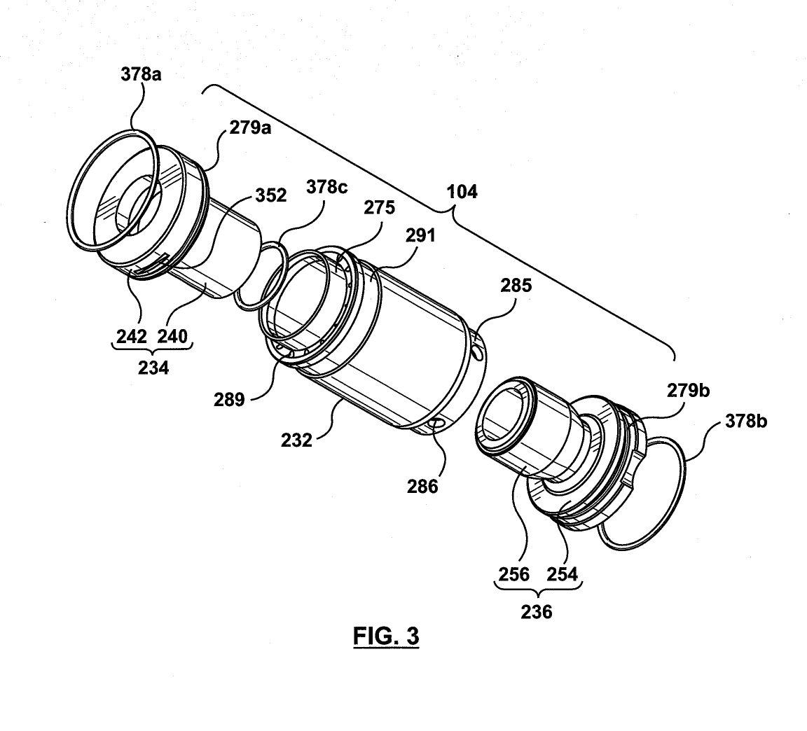

Referring now to FIG. 2, FIG. 2A, FIG. 2B and FIG. 3 in which FIG. 2 is an enlarged view of a portion of cavity half 112 of FIG. 1; FIG. 2A is a sectional view of FIG. 2 taken along line A-A; FIG. 2B is an enlarged view of a portion B of FIG. 2; and FIG. 3 is an exploded view of cavity assembly 104 of FIG. 2. Cavity assembly 104 includes a cavity insert 234, and a gate insert 236 located in a bore 238 that extends through cavity plate 128. In the current embodiment cavity half 112 includes a sleeve 230 that surrounds cavity assembly 104. Cavity insert 234 and gate insert 236 together define the external shape of the body portion and end portions of a preform produced in mold cavity 114. Cavity insert 234 exemplified herein includes a body forming portion 240 and a flange portion 242. Body forming portion 240 is generally tubular and extends in the upstream direction from flange portion 242. An inside surface 244 of body forming portion 240 defines the external shape of the body of a preform molded in mold cavity 114, and an outside surface 246 of body forming portion 240 defines a portion of the inner boundary of cooling passageway 148, whereas in outer boundary of cooling passageway is defined by a surrounding component.

Flange portion 242 extends radially outward from body forming portion 240 to define a shoulder 250 having an outside surface that is sized to be received in bore 238. Engagement between flange portion 242 and bore 238, as shown at location L1, aligns cavity insert 234 relative to bore 238. Flange portion 242 may further include features for assisting in extracting cavity insert 234 from bore 238 such as slots 352 shown in FIG. 3. Shoulder 250 of flange portion 242 further serves to axially locate alignment ring 130 relative to cavity insert 234. As shown in FIG. 1, alignment ring 130 ensures proper axial alignment between split thread inserts 122a, 122b, and thus core assembly 108, with cavity assembly 104 by way of interfaced tapers shown at locations T1 and T2.

Continuing with FIG. 2, FIG. 2A, FIG. 2B, and FIG. 3, gate insert 236 exemplified herein includes a nozzle receiving portion 254, an end forming portion 256, and a mold gate 258 located therebetween. Mold gate 258 defines an aperture through which molding material supplied by an injection molding machine (not shown) enters into mold cavity 114 via a hot runner system (not shown). In the current embodiment mold gate 258 is depicted as a cylindrical aperture sized to engage with a hot runner valve pin or stem (not shown) that is actuated to open and close mold gate 258 to control the flow of molding material into mold cavity 114. End forming portion 256 extends downstream from mold gate 258 and is generally cup shaped. An inside surface 260 of end forming portion 256 transitions from hemispherical to cylindrical to define the external shape of the closed end of a preform molded in mold cavity 114, and to also defines a portion of the external shape of the body of a preform molded in mold cavity 114. The shape of an outside surface 262 of end forming portion 256 generally conforms to the shape of inside surface 260 such that the wall thickness of end forming portion 256 can be considered constant. Outside surface 262 defines an upstream portion of an inner boundary of cooling passageway 148. In the embodiments disclosed herein, end forming portion 256 is configured to form a preform having a hemispherical end portion by way of example and not limitation. In an alternative embodiment (not shown) end forming portion is configured to form a preform having a conical, parabolic, or otherwise shaped end portion.

Nozzle receiving portion 254 extends in the upstream direction from mold gate 258. An inside surface 264 of nozzle receiving portion 254 defines a nozzle cut-out sized to receive a downstream end of a hot runner nozzle (not shown). An outside surface 266 of nozzle receiving portion 254 continues from outside surface 262 of end forming portion 256 and has a shape that generally conforms to a gate bubble adjacent to and upstream from, mold gate 258. Outside surface 266 of nozzle receiving portion 254 further defines a locating surface 267 which has a diameter that is sized to be received within bore 238. Engagement between outside surface 266 and bore 238 as shown at location L2, which is spaced apart from L1, aligns gate insert 236 relative to bore 238 in cavity plate 128.

In the current embodiment, a downstream end of gate insert 236 is configured to engage with the upstream end of cavity insert 234 as shown at stepped interface 268, whereby gate insert 236 and cavity insert 234 are concentrically aligned. In the current embodiment stepped interface is located midway along the body portion of a preform molded in mold cavity 114 such that outside surface 262 of end forming portion 256 defines the transition between the end and body forming portions of cavity assembly 104.

Cavity insert 234 and gate insert 236 are surrounded by cavity sleeve 232 which is generally tubular and has an outside surface 270 sized to be received in bore 238. In the current embodiment cavity sleeve 232 is sandwiched between an upstream face 272 of flange 242 and a shoulder 273 of nozzle receiving portion 254. An inside surface 274 of cavity sleeve 232 surrounds cavity insert body forming portion 240 and gate insert end forming portion 256 and is dimensionally larger than the outside surfaces 246, 262 thereof. Cavity and gate insert forming portions 240, 256 are spaced apart from inside surface 274 of cavity sleeve 232 which defines an outer boundary of cooling passageway 148.

Referring to FIG. 2B, in the current embodiment, cavity sleeve 232 is provided with a sleeve extension 275 that is positioned within a corresponding recess 276 in flange 242 at the downstream end of cavity insert 234. Sleeve extension 275 is configured with outside surfaces 275a, 275b being dimensionally smaller than the inside walls 276a 276b of recess 276, thereby defining a chamber extension 277 in fluid communication with cooling passageway 148 through which cooling fluid is able to flow to cool the downstream end of cavity insert 234. For the discussion provided herein, the chamber extension is generally referred to as hairpin chamber 277, having a generally annular, hairpin or double-backed shaped configuration that redirects the flow of cooling fluid from a direction that is generally downstream to a direction that is generally upstream.

Continuing with FIG. 2, FIG. 2A, FIG. 2B, and FIG. 3, in the current embodiment cavity insert 234 and gate insert 236 are readily separable, and are provided with suitable sealing features to ensure that cooling fluid is retained within cooling passageway 148. For example, seals such as o-rings 378a, 378b, shown in FIG. 3, are provided in grooves 279a, 279b on cavity insert 234 and gate insert 236 so as to create a fluid seals when cavity assembly 104 is positioned in bore 238. Further, a seal, such as o-ring 378c is provided in a groove 279c at stepped interface 268 between cavity insert 234 and gate insert 236 to prevent cooling fluid in cooling passageway 148 from entering mold cavity 114.

In the current embodiment cavity insert 234 is installed into bore 238 from the upstream face of cavity plate 128 when alignment ring 130 is removed therefrom, and gate insert 236 is installed into bore 238 from the downstream face of cavity plate 128. Cavity sleeve 232 may be installed in bore 238 from either the upstream face or the downstream face of cavity plate 128, provided that at least one of cavity insert 234 and gate insert 236 is removed from or is not installed in bore 238. In an alternative embodiment (not shown) cavity insert 234, gate insert 236 and cavity sleeve 232 are a unitary assembly that is brazed together or otherwise manufactured and retained in cavity plate 128 by alignment ring 130 and a mold plate (not shown) that is coupled to an upstream side of cavity plate 128.

Axial positioning of cavity assembly 104 within cavity plate 128 is maintained by engagement between a shouldered bore 280 in alignment ring 130 and downstream face 281 of cavity insert flange portion 242 and engagement between upstream face 282 of nozzle receiving portion 254 and an adjacent mold plate (not shown), for example, a manifold plate, such that cavity assembly 104 is sandwiched between alignment ring 130 and the mold plate when preform injection molding apparatus 100 is assembled. To prevent or reduce axial movement of cavity assembly 104 when cavity plate 128 is separated from the manifold plate, as shown in FIG. 3 a surface of gate insert nozzle receiving portion 254 adjacent to an upstream end of gate insert 236 is scalloped to engage with a head portion of a fastener, such as a socket head cap screw or the like (not shown) that is threaded into the upstream face of cavity plate 128.

In the current embodiment, cavity assembly 104 is positioned relative to injection molding apparatus 100 by virtue of engagement between cavity insert 234 and bore 238 at location L1 and engagement between gate insert 236 and bore 238 at location L2 by way of example and not limitation. In an alternate embodiment, (not shown) cavity insert 234 and gate 236 insert may be positioned relative to injection molding apparatus 100 by virtue of engagement between cavity insert 234 and gate insert 236 with cavity sleeve 232 which is accurately positioned within bore 238. In a further embodiment (not shown) cavity assembly 104 is positioned relative to injection molding apparatus 100 by engagement between one of cavity insert 234 and gate insert 236 with cavity sleeve 232 and engagement between the other of cavity insert 234 and gate insert 236 with bore 238.

As mentioned above, the arrangement of cavity insert 234, gate insert 236, and cavity sleeve 232 establishes cooling passageway 148. Cooling passageway 148 is generally annular and in fluid communication with a cooling fluid supply channel, for example supply channel 126 provided in cavity plate 128. A cooling fluid is circulated through cooling passageway 148 so as to maintain cavity and gate inserts 234, 236 at a suitable molding temperature that cools and solidifies the melt stream of moldable material injected into mold cavity 114.

As described herein, by way of example and not limitation, the flow of cooling fluid in cavity assembly 104 is generally in the downstream direction unless otherwise indicated; that is, in the same general direction as the flow of molding material in mold cavity 114. However, cooling channels within cavity assembly are configured to allow cooling fluid to flow in either the upstream or the downstream direction, depending on the configuration of the cooling fluid supply channels in cavity plate 128. As would be understood by one of ordinary skill in the art, plugs 283 can be secured in supply channels 126 at predetermined locations to ensure the flow of cooling fluid follows a desired flow path.

Having regard to FIG. 2 and also to FIG. 3, a flow of cooling fluid from supply channel 126 in cavity plate 128 intersects with a first surrounding channel 284 defined between bore 238 and a first reduced diameter portion 285 of cavity sleeve 232. First surrounding channel 284 permits cooling fluid to flow circumferentially around cavity sleeve 232. A radial passageway 286 traverses cavity sleeve 232 through reduced diameter portion 285 and serves as a fluid inlet to a decompression chamber 287. In the current embodiment cavity sleeve 232 includes a plurality of radial passageways 286, in the form of a plurality of circular shaped apertures, that are disposed at regular intervals around first reduced diameter portion 285 of cavity sleeve 232 such that cooling fluid enters decompression chamber 287 through a plurality of evenly spaced inlets. In another embodiment (not shown) radial passageways 286 are oval or otherwise shaped apertures connecting first surrounding channel 284 and decompression chamber 287, and in another embodiment (not shown) reduced diameter portion is provided with a plurality of axially extending castellations at an upstream end thereof that define radial passageways 286.

Decompression chamber 287 surrounds mold gate 258. Decompression chamber 287 has a cross-sectional area that is greater than the cross sectional area of cooling passageway 148, as such, the flow of cooling fluid passing through radial passageways 286 floods into decompression chamber 287 and surrounds mold gate 258 prior to flowing through cooling passageway 148. Together, decompression chamber 287 and cooling passageway 148 make up a cooling chamber that is defined between cavity assembly 104 and a surrounding structure that extends across end and body forming portions 256, 240 to create a transition therebetween that has an annular cross section, and through which cooling fluid is circulated to cool the end and body portions of a preform molded in mold cavity 114. Decompression chamber 287 is defined between gate insert 236 a surrounding structure, which in the current embodiment is cavity sleeve 232. More specifically, decompression chamber 287 is defined between inside surface 274 of cavity sleeve 232 and outside surfaces 262, 266 of gate insert end forming portion 256 and nozzle locating portion 254. The cross-sectional shape of decompression chamber 287 taken through a plane that is perpendicular to central axis 106 is annular, whereas the cross-sectional shape of decompression chamber 287 taken along a plane that is aligned with central axis 106 conforms to the shape of the closed end of a preform molded in mold cavity 114, and also conforms to the cross sectional shape of the gate bubble defined by inside surface 264 of nozzle receiving portion 254. In the current embodiment, the space between outside surface 262 of gate insert 236 and inside surface 274 of cavity sleeve 232 are shaped to create an annular funnel shaped transition between decompression chamber 287 and cooling passageway 148, which, in the current, embodiment is also the transition between end forming portion 256 and body forming portion 240. In other embodiments (not shown) the transition between end forming portion 256 and body forming portion 240 can be more abrupt, for example, a circular trough shaped transition.

Cooling passageway 148 projects from decompression chamber 287, and in the current embodiment is defined between gate and cavity inserts 236, 234, and cavity sleeve 232. Cooling passageway 148 is concentric about central axis 106 and encircles gate and cavity inserts 236, 234 to externally cool the body and end portions of a preform molded in mold cavity 114.

As shown in FIG. 2A, the cross-sectional shape of cooling passageway 148 taken along a plane that is perpendicular to central axis 106 is annular. Accordingly, the inside and outside boundaries of cooling passageway 148 has generally curved or circular shape. Cooling passageway 148 extends between gate insert 236 and cavity insert 234 and is configured so as to engulf the outside surfaces 262, 246 of end and body forming portions 256, 240 with the flow of cooling fluid when preform molding system 100 is in operation. The relative difference in the cross sectional areas between decompression chamber 287 and cooling passageway 148 create back-pressure therebetween that promotes turbulent flow of cooling fluid within cooling passageway 148. In other words, decompression of cooling fluid as it enters decompression chamber 287, in combination with constricting the flow of cooling fluid into cooling passageway 148, promotes a flow of cooling fluid that has a relatively flat annular flow front along the length of gate and cavity inserts 236, 234, whereby substantially the entire elongate annular cooling passageway 148 is in contact with a flow of cooling fluid that having a generally constant velocity. The annular flow of cooling fluid across gate insert 236 and cavity insert 234 promotes a radially uniform dissipation of heat from both the end and body portions of a preform created in mold cavity 114.

Referring to FIG. 2B, from a downstream end of cooling passageway 148, cooling fluid flows into hairpin chamber 277: Specifically, cooling fluid flows through a first chamber extension portion defined between sleeve extension surface 275a and flange recess wall 276a, and through into another or second decompression chamber 288 defined between sleeve extension surface 275b and flange recess wall 276b thereby defining the annular loop structure of hairpin chamber 277 whereby the direction of flow of cooling fluid doubles back.

Continuing with FIG. 2 and FIG. 3, a plurality of axial passageways 289 traverse cavity sleeve 232 through which cooling fluid flows to connect second decompression chamber 288 with a second surrounding channel 290 defined by a second reduced diameter portion 291 of cavity sleeve 232. After flowing through second surrounding channel 290, flow of cooling fluid exits cavity assembly 104 and flows into another supply channel 126′ in cavity plate 128, to an adjacent cavity assembly 104 (not shown) through which the flow of cooling fluid is reversed. In the current embodiment axial passageways 289 are depicted as a plurality of circular apertures that are disposed at regular intervals around cavity sleeve 232 and extend between second decompression chamber 288 and second reduced diameter portion 291. In an embodiment (not shown) axial passageways 289 are oval or otherwise shaped apertures connecting second decompression chamber 288 and second surrounding channel 290, and in another embodiment (also not shown) cavity sleeve 232 is provided with a plurality of radially extending castellations that define axial passageways 289.

In the current embodiment, to accommodate the flow of cooling fluid in either the upstream direction or the downstream direction, cavity assembly 104 defines two decompression chambers 287, 288, that is one decompression chamber in relation to each of the input and output ends of cooling passageway 148, with each of decompression chamber 287 and second decompression 288 chamber having a cross sectional area that is greater than the cross sectional area of cooling passageway 148. For example, if the flow of cooling fluid is generally in the upstream direction, since the cross-sectional area of second decompression chamber 288 is larger than the cross-sectional area of cooling passageway 148, cooling fluid is encouraged to encircle second decompression chamber 288 prior to flowing through hairpin chamber 277 and cooling passageway 148.

In each of the example embodiments disclosed herein cavity assembly 104 includes two decompression channels 287, 288 to facilitate the flow of cooling fluid in either the upstream or downstream direction. In an alternative embodiment (not shown) cavity assembly 104 includes a single decompression chamber 287, 288, that is, an decompression chamber at only an input end of cooling passageway 148 and cavity plate 128 includes supply channels configured to route the flow of cooling fluid to the cooling fluid inlet end of cavity assembly 104.

In the embodiments disclosed herein decompression chambers 287, 288 and cooling passageway 148 are configured as distinct chamber portions of a cooling chamber. In another embodiment (not shown) at least one of the decompression chamber 287 and the second decompression chamber 288, if included, can have a cross sectional area that is closer to, or can be considered equal to, the cross sectional area of the cooling passageway 148. I.e. the decompression chamber 287 and the second decompression 288 chamber function as extension portions of an extended cooling passageway 148 rather than as decompression chambers as described elsewhere herein. In such an embodiment, the extended cooling passageway cools both the end and body forming portions 256, 240 of the cavity assembly 104 and defines an annular shaped transition between the end and body forming portions 256, 240 of the cavity assembly.

In many known preform molding systems the cavity and gate insert cooling channels are not in fluid communication with each other, but are instead in fluid communication with separate cooling supply channels in a mold plate. In such systems there is a less cooled region of the cavity assembly in the area proximate to the interface of the cavity insert and the gate insert. In other known preform molding systems the cavity and gate insert cooling channels are in fluid communication with each other via a bridge channel that crosses the interface between the cavity and gate insert at a single location that is spaced apart from the cavity assembly molding surface. In such systems there is also a less cooled region of the cavity assembly in the area proximate to the interface between the cavity insert and the gate insert since the bridge channel crosses between the gate and cavity insert at only one side thereof.

Cooling passageway 148 has an elongate annular or tubular configuration that encapsulates, or ensheathes gate and cavity insert outside surfaces 262, 246. Accordingly, a preform molded in mold cavity 114 is subjected to cooling along its external circumference and across the transition between its body end portions. Effective cooling of the end portion of a preform is important since this area is formed in the last portion of mold cavity 114 to fill with molding material, and as such, is the portion of the preform that is subject to the shortest amount of in-mold cooling time.

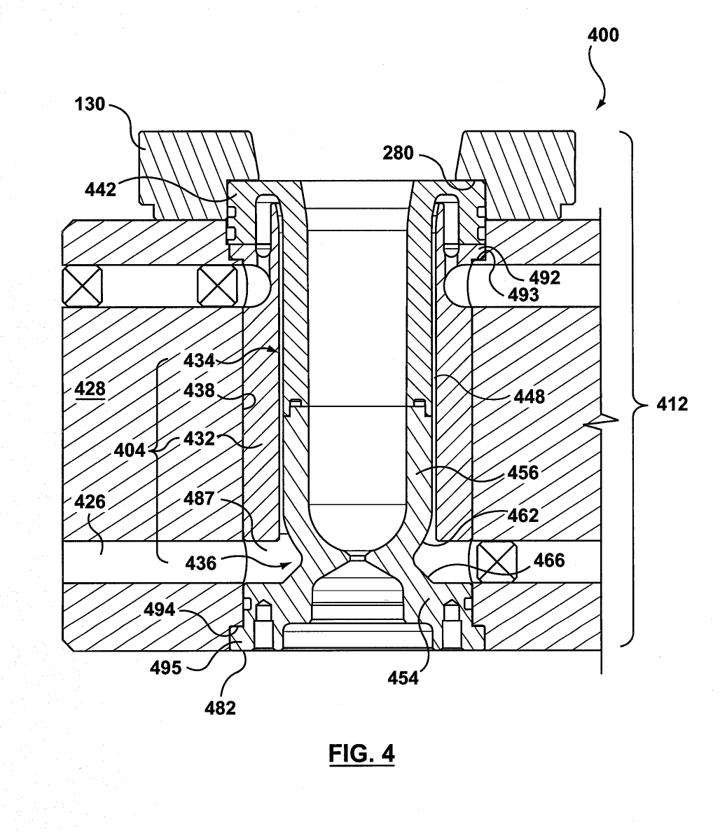

Referring now to FIG. 4, which is cross sectional view of a portion of a cavity half 412 of a preform injection molding apparatus 400 having a cavity assembly 404 in accordance with another embodiment hereof. In the description of the current embodiment, the previous embodiments can be referenced for additional description of like parts, as only differences are discussed in detail below. Features and aspects described in other embodiments can be used accordingly with the present embodiment, and vice versa.

Cavity assembly 404 includes gate insert 436 cavity insert 434, and cavity sleeve 432 located within bore 438 extending through a cavity plate 128. In the current embodiment, the upstream end of cavity sleeve 432 does not include a first reduced diameter portion. Accordingly a flow of cooling fluid in supply channel 426 is fed directly into decompression chamber 487, which, in the current embodiment, is defined between bore 438 in cavity plate 428, the outside surfaces 462, 466 of gate insert body and nozzle receiving portions 456, 454, and an upstream face of cavity sleeve 432. Cavity insert 434 and gate insert 436 are readily separable, and are provided with suitable sealing features to ensure that cooling fluid is retained within cooling passageway 448. In an alternative embodiment (not shown) cavity insert 434 and cavity sleeve 432 are a unitary assembly that is brazed together or otherwise manufactured, e.g. additive manufactured, and retained in cavity plate 428 by alignment ring 130.

To maintain positioning of cavity sleeve 432 relative to the remainder of cavity assembly 404, a radially extending flange 492 is provided at a downstream end thereof such that when alignment ring 130 is secured to cavity plate 428, by threaded fasteners or the like (not shown), shouldered bore 280 of alignment ring 130 bears upon cavity insert flange portion 442 to sandwich cavity sleeve flange 492 against a step 493 at the downstream end of bore 438. An upstream end of bore 438 is also provided with a step 494 which receives a complementary sized flange 495 extending radially from upstream face 482 of gate insert 436 such that flange 495 is sandwiched between step 494 and an adjacent mold plate (not shown) when injection molding apparatus 400 is assembled.

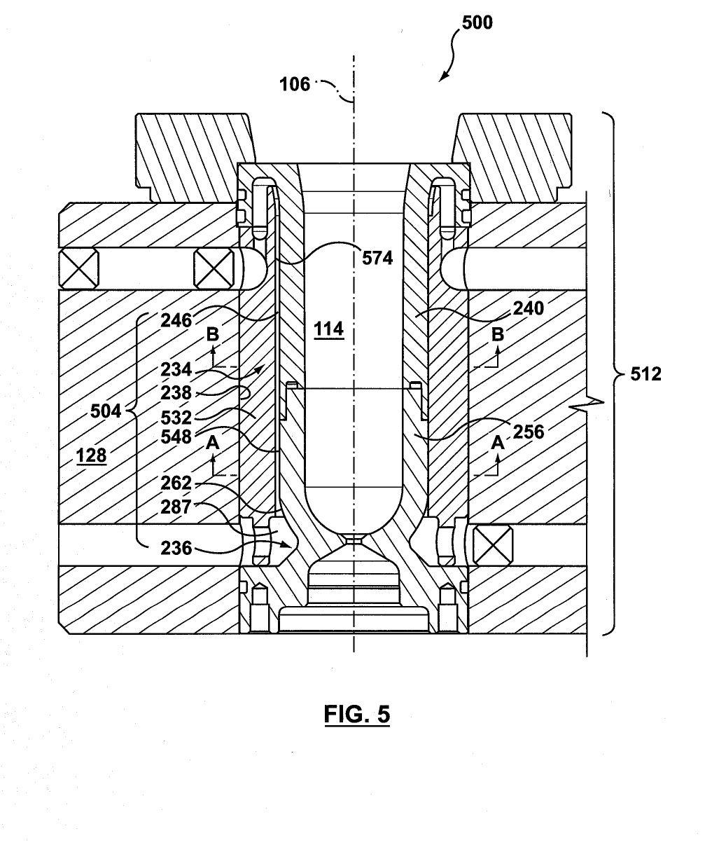

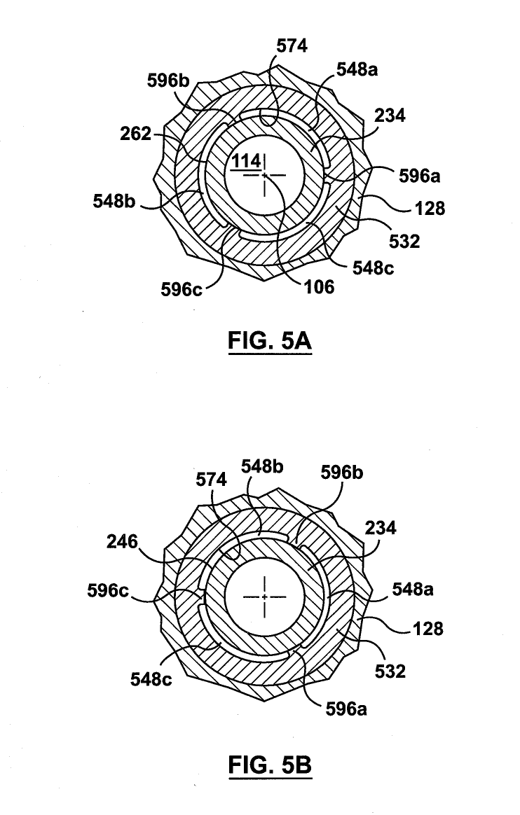

Referring now to FIG. 5, FIGS. 5A, and 5B, in which FIG. 5 is cross sectional view of a portion of a cavity half 512 of a preform injection molding system 500 having a cavity assembly 504 in accordance with another embodiment hereof; FIG. 5A is a sectional view of FIG. 5 taken along line A-A; and FIG. 5B is a sectional view of FIG. 5 taken along line B-B. In the description of the current embodiment, the previous embodiments can be referenced for additional description of like parts, as only differences are discussed in detail below. Features and aspects described in other embodiments can be used accordingly with the present embodiment, and vice versa.

Cavity assembly 504 includes gate insert 236, cavity insert 234, and cavity sleeve 532 located in within bore 238 extending through cavity plate 128. In the current embodiment, the arrangement of cavity insert 234, gate insert 236, and cavity sleeve 532 establishes an annular cooling passageway 548 that is made up of a plurality of elongate arcuate channel segments 548a, 548b, 548c that extend between cavity insert 234 and gate insert 236 and uniformly surround and extends substantially the entire length of mold cavity 114. As shown in FIG. 5A, three channel segments 548a, 548b, 548c are depicted; however, more or fewer channel segments are contemplated. Cavity insert 234 and gate insert 236 are readily separable, and are provided with suitable sealing features to ensure that cooling fluid is retained within cooling passageway 548. In an alternative embodiment (not shown) cavity insert 234, gate insert 236 and cavity sleeve 532 are a unitary assembly that is brazed together or otherwise manufactured, e.g. additive manufactured, and retained in cavity plate 128 by alignment ring 130 and a mold plate (not shown) that is coupled to cavity plate 128.

Each channel segment 548a, 548b, 548c is defined between gate insert 236 and cavity insert 234, and cavity sleeve 532 and projects from decompression chamber 287 to extends along central axis 106 from gate insert 236 to cavity insert 234. More specifically, each channel segment 548a, 548b, 548c is defined between outside surfaces 262, 246 of cavity and gate insert forming portions 240, 256 and inside surface 574 of cavity sleeve 532, and is segmented from an adjacent channel segment 548a, 548b, 548c by a divider 596a, 596b, 596c that extends radially inward from cavity sleeve 532 between inside surface 574 of cavity sleeve 532 and outside surfaces 246, 262 of cavity and gate insert forming portions 240, 256. In addition to segmenting cooling passageway 548 into a plurality of channel segments 548a, 548b, 548c, dividers 596a, 596b, 596c also radially supports cavity insert 234 and gate insert 236 against injection pressure when injection molding apparatus 500 is in operation and molding material is injected into mold cavity 114.

In the current embodiment each divider 596a, 596b, 596c, and subsequently each channel segment 548a, 548b, 548c, follows a substantially linear pathway along the length of mold cavity 114. However, in another embodiment, each divider 596a, 596b, 596c and subsequently each channel segment 548a, 548b, 548c is follows a generally helical pathway along the length of mold cavity, such that each channel segment 548a, 548b, 548c revolves around central axis 106 as it extends along the length of mold cavity 114. That is, as shown in FIG. 5A, at a cross section of cavity assembly 504 taken along line A-A of FIG. 5, dividers 596a, 596b, 596c have a first angular position relative to central axis 106, whereas, as shown in FIG. 5B, at a cross section of cavity assembly 504 taken along line B-B of FIG. 5 dividers 596a, 596b, 596c have a different angular position relative to central axis 106.

Although dividers 596a, 596b, 596c are depicted as projecting inward from cavity sleeve 532, in another embodiment (not shown), dividers 596a, 596b, 596c project radially outward from cavity insert 234 and/or from gate insert 236.

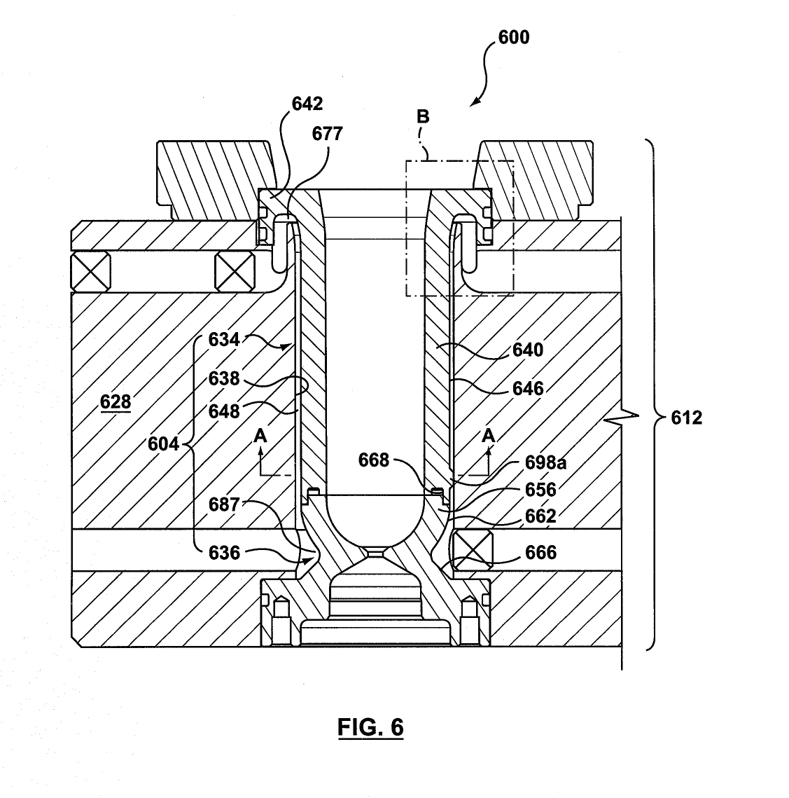

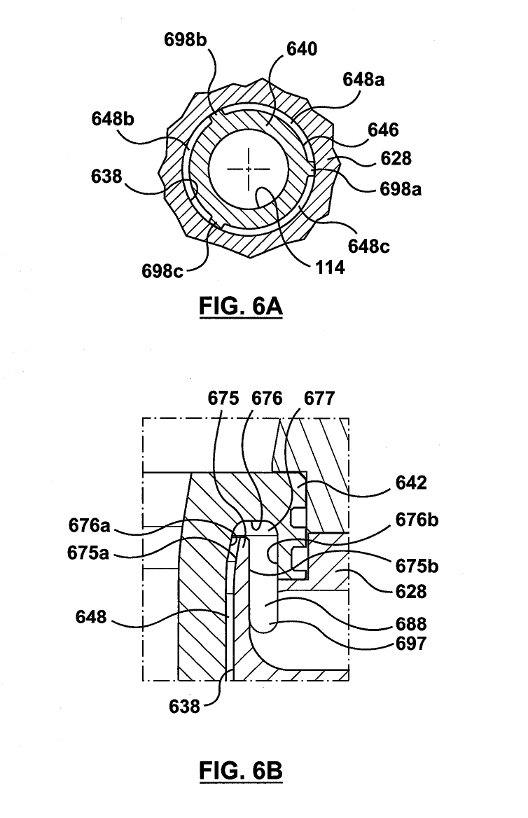

Referring now to FIG. 6. FIG. 6A, and FIG. 6B, in which FIG. 6 is cross sectional view of a portion of a cavity half 612 of a preform injection molding system 600 having a cavity assembly 604 in accordance with another embodiment hereof; FIG. 6A is a sectional view of FIG. 6 A taken along line A-A; and FIG. 6B is an enlarged view of a portion B of FIG. 6. In the description of the current embodiment, the previous embodiments can be referenced for additional description of like parts, as only differences are discussed in detail below. Features and aspects described in other embodiments can be used accordingly with the present embodiment, and vice versa.

In the current embodiment cavity assembly 604 includes a cavity insert 634, and a gate insert 636 located within bore 638 extending through cavity plate 628. The arrangement of cavity insert 634, gate insert 636, and bore 638 defines elongate annular cooling passageway 648 and decompression chamber 687. Decompression chamber 687 and cooling passageway 648 make up a cooling chamber that is defined between cavity assembly 504 and a surrounding structure, which in the current embodiment is bore 638 in cavity plate 628. More specifically, bore 638 is dimensionally larger than outside surfaces 646, 662 of cavity and gate insert forming portions 640, 656 such that bore 638 defines an outer boundary of cooling passageway 648. An inner boundary of cooling passageway 648 is defined by outside surfaces 646, 662 of cavity and gate insert body portions 640, 656. Decompression chamber 687 is defined between bore 638 and outside surfaces 662, 666 of gate insert body and nozzle locating portions 656, 654. Cavity insert 634 and gate insert 636 are readily separable, and are provided with suitable sealing features to ensure that cooling fluid is retained within cooling passageway 648.

In the current embodiment, hairpin chamber 677 is defined between cavity plate 628 and flange portion 642 of cavity insert 634. Referring to FIG. 6B, cavity plate 628 is provided with a groove 697 that is concentric to bore 638 to define an extension member 675 that is positioned within a corresponding recess 676 in flange portion 642 of cavity insert 634. Extension member 675 is configured with outside surfaces 675a, 675b being dimensionally smaller than the inside walls 676a, 676b of corresponding recess 676 in flange 642, thereby defining a chamber extension in fluid communication with cooling passageway 648. As such, cooling fluid that flows through cooling passageway 648 is directed through cooling passageway 648 of the elongated body portion, and also through a first chamber extension portion defined between extension member surface 675a and flange recess wall 676a, and into a second decompression chamber 688 defined between sleeve extension surface 675b and flange recess 676 wall 676b thereby defining the annular loop structure of hairpin chamber 677.

Returning to FIG. 6 and to FIG. 6A, in the current embodiment outside surface 646 of cavity insert body portion 640 extends further in upstream direction than in the previous embodiments such that stepped interface 668 between cavity insert 634 and gate insert 636 is positioned upstream relative to the previous embodiments. In the current embodiment stepped interface is located at the transition between the end and body portions of a preform molded in mold cavity 114 such that the transition between the end and body forming portions of cavity assembly 104 is at the interface between gate insert 636 and cavity insert 634.

Cavity insert body portion 640 includes a plurality of stand-offs 698a, 698b, 698c extending between cavity insert body portion 640 and bore 638. In the current embodiment stand-offs 698a, 698b, 698c are provided in the form of localized protrusions extending radially outward from cavity insert body portion 640 proximate to stepped interface 668. As shown in FIG. 6A, stand-offs 698a, 698b, 698c segment a portion of annular cooling passageway 648 into a plurality of arcuate channel segments 648a 648b 648c. Stand-offs 698a, 698b, 698c radially support cavity insert 634 and gate insert 636 against injection pressure when injection molding apparatus 600 is in operation and molding material is injected into mold cavity 114.

While stand-offs 698a, 698b, 698c are shown projecting radially outward from cavity insert 634, in an alternative embodiment (not shown) stand-offs 698a, 698b, 698c project radially outward from outside surface of 662 of gate insert body portion 656. In another embodiment (not shown) stand-offs 698a, 698b, 698c project radially inward from bore 638 in cavity plate 628. Further, in another embodiment (not shown) cavity assembly 604 may includes stand-offs 698a, 698b, 698c at different locations along the length of cooling passageway 648 that in combination radially support cavity insert 634 and/or gate insert 636 against injection pressure when injection molding apparatus 600 is in operation and molding material is injected into mold cavity 114.

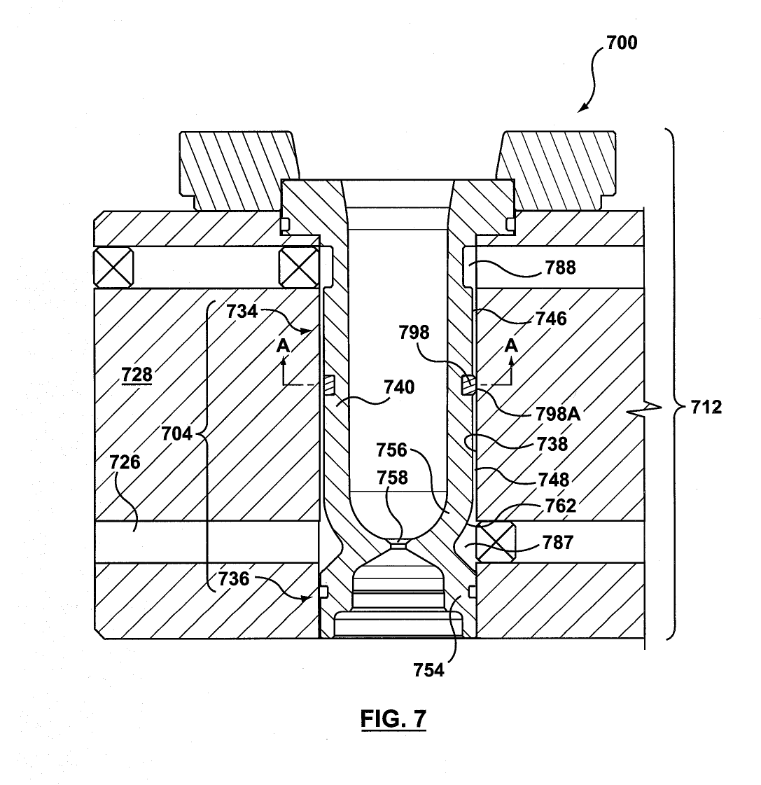

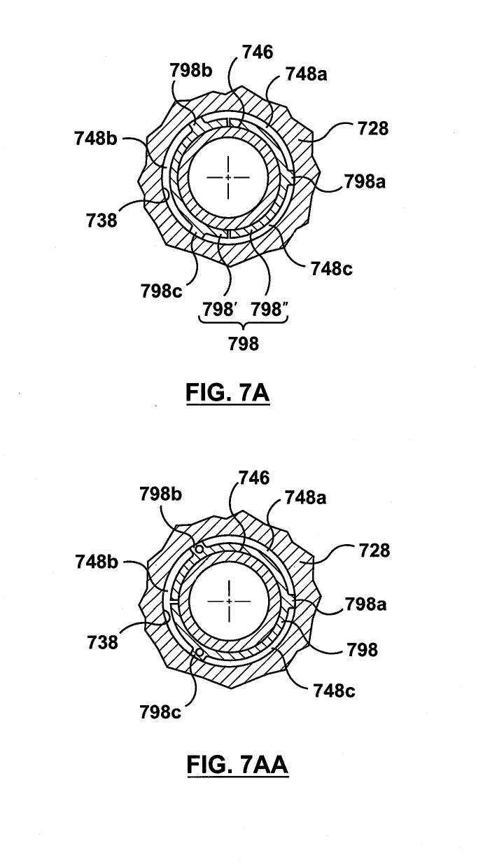

Referring now to FIG. 7, FIG. 7A, and FIG. 7B, in which FIG. 7 is cross sectional view of a portion of a cavity half 712 of a preform injection molding system 700 having a cavity assembly 704 in accordance with another embodiment hereof; FIG. 7A is a sectional view of FIG. 7A taken along line A-A; and FIG. 7AA is an alternative sectional view of FIG. 7 taken along line A-A. In the description of the current embodiment, the previous embodiments can be referenced for additional description of like parts, as only differences are discussed in detail below. Features and aspects described in other embodiments can be used accordingly with the present embodiment, and vice versa.

In the current embodiment cavity assembly 704 includes a unitary body having a cavity portion 734, and a gate portion 736 extending within bore 738, and includes a stand-off ring 798 extending between cavity portion 734 and bore 736. The arrangement of cavity portion 734, gate portion 736, and bore 738 defines decompression chamber 787 and cooling passageway 748, and also defined second decompression chamber 788. Decompression chamber 787 and cooling passageway 748 make up a cooling chamber that is defined between cavity assembly 704 and a surrounding structure, which in the current embodiment is bore 738 in cavity plate 728. More specifically, bore 738 is dimensionally larger than outside surfaces 746, 762 of cavity and gate forming portions 740, 756 such that bore 738 defines an outer boundary of cooling passageway 748, and an inner boundary of cooling passageway 748 is defined by outside surfaces 746, 762 of cavity and gate portions 740, 756. Decompression chamber 787 is defined between bore 738 and outside surfaces 762, 766 of the body and nozzle locating portions 756, 754 of gate portion 736; and second decompression chamber 788 is defined between bore 738 and a reduced diameter portion of outside surface 762 of cavity portion 734. In the current embodiment, cooling fluid flows from supply channel 726 into decompression chamber 787 where it surrounds mold gate 758 and then flows into cooling passageway 748. From annular cooling passageway 748, cooling fluid flows directly into second decompression chamber 788 without passing thought a hairpin chamber since such a feature is absent in preform molding system 700. In the current embodiment stepped interface is located at the transition between the end and body portions of a preform molded in mold cavity 114, i.e. at the interface between cylindrical outside surface 746 and hemispherical outside surface 762.

In the current embodiment outside surface 746 of cavity portion 740 includes a groove extending therearound sized to receive stand-off ring 798 which includes a plurality of stand-offs 798a, 798b, 798c extending between cavity insert portion 740 and bore 738. Stand-offs 798a, 798b, 798c are provided in the form of localized protrusions extending radially outward from stand-off ring 798.

Referring now to FIG. 7A, stand-off ring 798 is provided in the form of a split ring having a segment 798′ and a segment 798″ with stand-off 798a extending radially outward from segment 798′ and stand-offs 798b, 798c extending radially outward from stand-off 798″.

Referring now to FIG. 7AA, stand-off ring 748 is provided in the form or a unitary split ring. As shown in FIG. 7A, and FIG. 7AA, stand-offs 798a, 798b, 798c segment a portion of annular cooling channel 748 into a plurality of channel segments 748a 748b 748c.

Each stand-off 798a, 798b, 798c radially supports cavity portion 734 against injection pressure when injection molding apparatus 700 is in operation and molding material is injected into mold cavity 114. Further, although only one stand-off ring 798 is shown, cavity assembly 704 may include a plurality of stand-off rings 798 at different locations along the length of cooling passageway 748.

In each of the example embodiments disclosed herein, the inside and outside surfaces that define the boundaries of cooling chamber 148 and decompression chambers 287, 288 are substantially smooth surfaces by way of example and not limitation. In an alternative embodiment (not shown) the inside and/or the outside surfaces that define the boundaries of cooling chamber 148 and decompression chambers 287, 288 are textured, for example dimpled to increased the respected wetted surfaces thereof. In a further embodiment the inside and/or the outside surfaces that define the boundaries of cooling chamber 148 are formed as a plurality of axially extending grooves, the sum of which forms a generally curved boundary of cooling passageway 148.

It will be understood that all components of the mold stack assembly described herein may be made of suitable material commonly used in injection molding devices. For example, components may be made of conventional tool steel, stainless steel, or other suitable material, for example, a copper alloy, that is able to withstand the pressures and temperatures associated with injection molding.

While various embodiments according to the present invention have been described above, it should be understood that they have been presented by way of illustration and example only, and not limitation. It will be apparent to persons skilled in the relevant art that various changes in form and detail can be made therein without departing from the scope of the invention. Thus, the breadth and scope of the present invention should not be limited by any of the above-described exemplary embodiments, but should be defined only in accordance with the appended claims and their equivalents. It will also be understood that each feature of each embodiment discussed herein, and of each reference cited herein, can be used in combination with the features of any other embodiment. All patents and publications discussed herein are incorporated by reference herein in their entirety.

1-57. (canceled)

58. A preform molding apparatus for molding a preform, the preform molding apparatus comprising:
a cavity assembly having an end forming portion that extends from a mold gate and defines an external shape of a closed end of the preform, and a body forming portion that defines an external shape of a body of the preform; and
a cooling chamber defined between the end forming portion and the body forming portion and a surrounding component, the cooling chamber for cooling the preform molded in the cavity assembly,
wherein the cooling chamber surrounds the mold gate and has an annular cross-sectional shape that extends between the end forming portion and the body forming portion of the cavity assembly.

59. The preform molding apparatus of claim 58, wherein the cooling chamber includes a decompression chamber that surrounds the mold gate, and an annular cooling passageway that projects from the decompression chamber along a length of the body forming portion, the decompression chamber having a greater cross-sectional area than a cross-sectional area of the annular cooling passageway.

60. The preform molding apparatus of claim 59 further comprising:
a second decompression chamber at an opposite end of the annular cooling passageway as the decompression chamber, the second decompression chamber having a greater cross-sectional area than the cross-sectional area of the annular cooling passageway.

61. The preform molding apparatus of claim 59 wherein an outside surface of the end forming portion and an inside surface of the surrounding component are shaped to create an annular funnel shaped transition between the decompression chamber and the annular cooling passageway.

62. The preform molding apparatus of claim 58 further comprising:
a plurality of dividers extending between the cavity assembly and the surrounding component so as to divide the cooling chamber into a plurality of arcuate channel segments.

63. The preform molding apparatus of claim 58, further comprising:
a plurality of stand-offs extending between the cavity assembly and the surrounding component, wherein the plurality of stand-offs apportion the cooling chamber into a plurality of arcuate channel segments.

64. The preform molding apparatus of claim 63, wherein the plurality of stand-offs are defined by a stand-off ring positioned between the cavity assembly and the surrounding component.

65. The preform molding apparatus of claim 58, wherein the cavity assembly includes a gate insert that defines the end forming portion of the cavity assembly, and a cavity insert that defines at least a portion of the body forming portion of the cavity assembly.

66. The preform molding apparatus of claim 65, wherein the gate insert and the cavity insert are separable, and wherein the cooling chamber extends across the interface between the gate insert and the cavity insert.

67. The preform molding apparatus of claim 66, wherein the gate insert further defines a portion of the body forming portion of the cavity assembly.

68. The preform molding apparatus of claim 66, wherein a downstream end of the gate insert and an upstream end of the cavity insert engage at a stepped interface, and whereby the gate insert and the cavity insert are concentrically aligned.

69. The preform molding apparatus of claim 58, wherein the surrounding component is a sleeve component received in a bore in a mold plate.

70. The preform molding apparatus of claim 69, further comprising:
a first surrounding channel between the bore in the mold plate and the sleeve component, and a plurality of radial passageways that are in fluid communication between the first surrounding channel and the cooling chamber.

71. The preform molding apparatus of claim 69, wherein the sleeve component includes a sleeve extension that is positioned within a recess in a flange of a cavity insert, the sleeve extension being smaller than the recess to define a chamber extension configured to redirect the flow of cooling fluid.

72. The preform molding apparatus of claim 71, wherein the chamber extension includes a second decompression chamber defined between an outside surface of the sleeve extension and an inside surface of the recess in the flange.

73. The preform molding apparatus of claim 72, further comprising:
a second surrounding channel between the bore in the mold plate and the sleeve component, and a plurality of axial passageways that are in fluid communication between the second surrounding channel and the second decompression chamber.

74. The preform molding apparatus of claim 58, wherein the surrounding component is a mold plate.

75. The preform molding apparatus of claim 74, wherein the mold plate includes an extension member that is positioned within a recess in a flange of a cavity insert, the extension member being smaller than the recess to define a chamber extension configured to redirect the flow of cooling fluid.

76. The preform molding apparatus of claim 75, wherein the chamber extension includes a second decompression chamber defined between an outside surface of the extension member and an inside surface of the recess in the flange.

77. The preform molding apparatus of claim 58, wherein the end forming portion and the body forming portion are respective portions of a unitary body.
